(19) United States
(12) Patent Application Publication
(10) Pub. No.: US 2026/0333435 A1
(43) Pub. Date: Oct. 22, 2026

(54) METHOD FOR DYNAMICALLY DETERMINING BANDWIDTH OF RESPONSE FRAME AND ASSOCIATED WIRELESS COMMUNICATION DEVICE

(71) Applicant: MEDIATEK INC., Hsinchu City (TW)

(72) Inventors: Chun-Ting Lin, Hsinchu City (TW); Jun-Shen Chen, Hsinchu City (TW); Cheng-Yu Wu, Hsinchu City (TW); Li-Tien Chang, Hsinchu City (TW); Yu-Ming Wen, Hsinchu City (TW); Tsung-Hsuan Wu, Hsinchu City (TW); Chu-Yi Ho, Hsinchu City (TW)

(73) Assignee: MEDIATEK INC., Hsinchu City (TW)

(21) Appl. No.: 19/649,101

(22) Filed: Apr. 15, 2026

Related U.S. Application Data
(60) Provisional application No. 63/789,446, filed on Apr. 16, 2025.
(60) Provisional application No. 63/903,799, filed on Oct. 22, 2025.

(51) Int. Cl. H04W 74/0816; H04B 17/318; H04L 1/00; H04L 5/00; H04W 76/20

(52) U.S. Cl. CPC H04W 74/0816; H04B 17/318; H04L 1/0003; H04L 5/0053; H04W 76/20

(57) ABSTRACT

A method for dynamically determining a bandwidth of a response frame includes: receiving, by a first wireless communication device, a request frame from a second wireless communication device; dynamically determining, by the first wireless communication device, the bandwidth of the response frame according to a performance indicator associated with a transmission or a reception of the first wireless communication device; and in response to reception of the request frame, transmitting, by the first wireless communication device, the response frame to the second wireless communication device with the determined bandwidth.

### CROSS REFERENCE TO RELATED APPLICATIONS

This application claims the benefit of U.S. Provisional Application No. 63/789,446, filed on Apr. 16th, 2025. Further, this application claims the benefit of U.S. Provisional Application No. 63/903,799, filed on Oct. 22nd, 2025. The contents of these applications are incorporated herein by reference.

### BACKGROUND

The present disclosure is related to wireless communication, and more particularly, to a method for dynamically determining a bandwidth of a response frame and an associated wireless communication device.

In a wireless communication system, due to factors such as chip capability, regulatory limitations, and types of power amplifiers (PAs), a transmission power spectrum density (PSD) gap may exist between the transmission PSD of a transmission side (e.g., an access point (AP)) for transmitting a request frame (e.g., a request to send (RTS) frame) and the transmission PSD of a reception side (e.g., a station (STA)) for transmitting a response frame (e.g., a clear to send (CTS) frame), which may significantly degrade system performance. For example, assume that the transmission side requires transmitting data to the reception side. Initially, the transmission side transmits a request frame (e.g., an RTS frame) to the reception side, and the reception side transmits a response frame (e.g., a CTS frame) to the transmission side in response to reception of the request frame. Due to the transmission PSD gap, however, the transmission side may fail to receive the response frame, thereby resulting in multiple retransmission events of the request frame (e.g., the RTS frame).

When the number of retransmission events exceeds a predetermined value, the transmission side may switch to transmitting a CTS-to-self frame so as to ensure successful transmission of the data and reception of an acknowledgment frame from the reception side. In this case, redundant request frame retransmissions may cause additional overhead and reduce data transmission efficiency.

### SUMMARY

It is there one of the objectives of the present disclosure to provide a method for dynamically determining a bandwidth of a response frame, in order to address the above-mentioned issues.

According to an embodiment of the present disclosure, a method for dynamically determining a bandwidth of a response frame is provided. The method comprises: receiving, by a first wireless communication device, a request frame from a second wireless communication device; dynamically determining, by the first wireless communication device, the bandwidth of the response frame according to a performance indicator associated with a transmission or a reception of the first wireless communication device; and in response to reception of the request frame, transmitting, by the first wireless communication device, the response frame to the second wireless communication device with the determined bandwidth.

In an embodiment, the method further comprises: determining whether data traffic of the first wireless communication device is presented in order to generate a determination result, wherein the bandwidth of the response frame is dynamically determined according to the performance indicator associated with the determination result.

In an embodiment, in response to the data traffic of the first wireless communication device not being presented, the performance indicator is a received signal strength indicator (RSSI) of a received packet from the second wireless communication device.

In an embodiment, the step of dynamically determining, by the first wireless communication device, the bandwidth of the response frame according to the performance indicator associated with the determination result comprises: determining whether the RSSI is less than or equal to a threshold RSSI; in response to the RSSI being less than or equal to the threshold RSSI, determining the bandwidth of the response frame as a first bandwidth, wherein the first bandwidth is narrower than a bandwidth of the request frame; and in response to the RSSI not being less than or equal to the threshold RSSI, determining the bandwidth of the response frame as a second bandwidth, wherein the second bandwidth is the bandwidth of the request frame.

In an embodiment, in response to the data traffic of the first wireless communication device being presented, the performance indicator is a transmission bandwidth of transmitted data of the first wireless communication device.

In an embodiment, a connection capability bandwidth is a bandwidth negotiated between the first wireless communication device and the second wireless communication device for communication when a connection is established between the first wireless communication device and the second communication; and the step of dynamically determining, by the first wireless communication device, the bandwidth of the response frame according to the performance indicator associated with the determination result comprises: determining whether the transmission bandwidth of transmitted data is less than the connection capability bandwidth; in response to the transmission bandwidth of transmitted data being less than the connection capability bandwidth, determining the bandwidth of the response frame as a first bandwidth, wherein the first bandwidth is narrower than a bandwidth of the request frame; and in response to the transmission bandwidth not being less than the connection capability bandwidth, determining the bandwidth of the response frame as a second bandwidth, wherein the second bandwidth is the bandwidth of the request frame.

In an embodiment, in response to the data traffic of the first wireless communication device being presented, the performance indicator is a Modulation and Coding Scheme (MCS) of transmitted data of the first wireless communication device.

In an embodiment, the step of dynamically determining, by the first wireless communication device, the bandwidth of the response frame according to the performance indicator associated with the determination result comprises: determining whether the MCS of transmitted data is less than a threshold MCS; in response to the MCS of transmitted data being less than the threshold MCS, determining the bandwidth of the response frame as a first bandwidth, wherein the first bandwidth is narrower than a bandwidth of the request frame; and in response to the MCS of transmitted data not being less than the threshold MCS, determining the bandwidth of the response frame as a second bandwidth, wherein the second bandwidth is the bandwidth of the request frame.

In an embodiment, a connection capability bandwidth is a bandwidth negotiated between the first wireless communication device and the second wireless communication device for communication when a connection is established between the first wireless communication device and the second wireless communication device, a transmission power gap is between a first power with the connection capability bandwidth for transmitting the response frame and a second power with a predetermined bandwidth for transmitting an acknowledgment frame; and in response to the data traffic of the first wireless communication device being presented, the performance indicator is the transmission power gap.

In an embodiment, the step of dynamically determining, by the first wireless communication device, the bandwidth of the response frame according to the performance indicator associated with the determination result comprises: determining whether the transmission power gap is less than a threshold power gap; in response to the transmission power gap being less than the threshold power gap, determining the bandwidth of the response frame as a first bandwidth, wherein the first bandwidth is narrower than a bandwidth of the request frame; and in response to the transmission power gap not being less than the threshold power gap, determining the bandwidth of the response frame as a second bandwidth, wherein the second bandwidth is the bandwidth of the request frame.

In an embodiment, in response to the data traffic of the first wireless communication device being presented, the performance indicator is a data rate of transmitted data of the first wireless communication device.

In an embodiment, the step of dynamically determining, by the first wireless communication device, the bandwidth of the response frame according to the performance indicator associated with the determination result comprises: determining the bandwidth of the response frame as a first bandwidth when the data rate of transmitted data is less than a threshold data rate, wherein the first bandwidth is narrower than a bandwidth of the request frame; and determining the bandwidth of the response frame as a second bandwidth when the data rate of transmitted data is not less than the threshold data rate, wherein the second bandwidth is the bandwidth of the request frame.

In an embodiment, the determined bandwidth is a bandwidth of an acknowledgment frame from the first wireless communication device to the second wireless communication device, and the bandwidth of the acknowledgment frame is narrower than a bandwidth of the request frame.

According to an embodiment, a wireless communication device is provided, wherein the wireless communication device comprises a wireless transceiver circuit and a processor. The processor is coupled to the wireless transceiver circuit, and is arranged to perform operations comprising: receiving a request frame from another wireless communication device; dynamically determining a bandwidth of a response frame according to a performance indicator associated with a transmission or a reception of the wireless communication device; and in response to reception of the request frame, transmitting the response frame to the another wireless communication device with the determined bandwidth.

One of the benefits of the present disclosure is that, by the method and the wireless communication device of the present disclosure, the bandwidth of the response frame (e.g., the CTS frame) can be dynamically determined according to the performance indicator, which can minimize the transmission PSD gap between a transmission PSD of the second wireless communication device for transmitting the request frame (e.g. the RTS frame) and a transmission PSD of the first wireless communication device for transmitting the response frame (e.g., the CTS frame) within a wireless communication environment. More particularly, retransmission events of the request frame (e.g. the RTS frame) caused by the second wireless communication device being unable to receive the response frame (e.g., the CTS frame) can be prevented, thereby effectively reducing system costs and improving data transmission efficiency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication device according to an embodiment of the present disclosure.

FIG. 2 is a communication flow between two wireless communication devices according to an embodiment of the present disclosure.

FIG. 3 is a flow chart of dynamically determining a bandwidth of a response frame for a normal traffic case and a low traffic case according to an embodiment of the present disclosure.

FIG. 4 is a flow chart of a method for dynamically determining a bandwidth of a response frame according to an embodiment of the present disclosure.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms "include" and "comprise" are used in an open-ended fashion, and thus should be interpreted to mean "include, but not limited to ...".

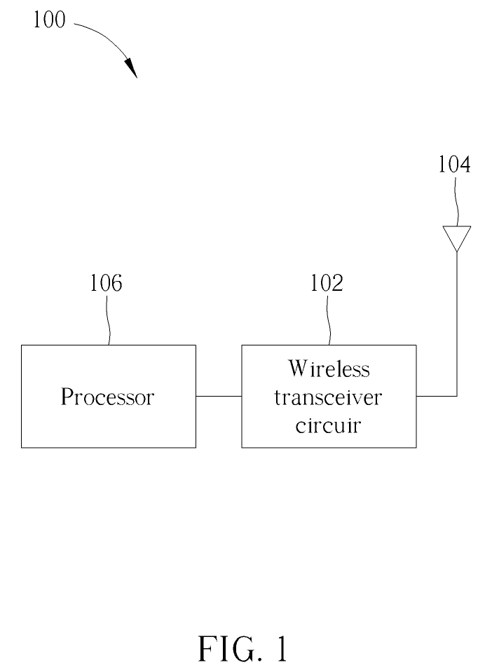

FIG. 1 is a diagram illustrating a wireless communication device 100 according to an embodiment of the present disclosure. For example, the wireless communication device 100 may operate according to the embodiments of the present disclosure. In addition, the wireless communication device 100 may be implemented as an access point (AP) and may also be implemented as a non-AP station (STA), depending upon actual design requirements. As shown in FIG. 1, the wireless communication device 100 may include a wireless transceiver circuit 102 (such as one or more transceiver), at least one antenna 104, and a processor 106. The processor 106 is arranged to perform communications via a wireless transmission channel through the wireless transceiver circuit 102 according to the embodiments of the present disclosure. For example, the wireless transceiver circuit 102 may receive a wireless signal from the wireless transmission channel via the at least one antenna 104, and process the wireless signal to obtain a received frame/packet. The wireless transceiver circuit 102 may also process a frame/packet to be transmitted in order to obtain a corresponding signal as a wireless signal, and transmit the wireless signal via the at least one antenna 104.

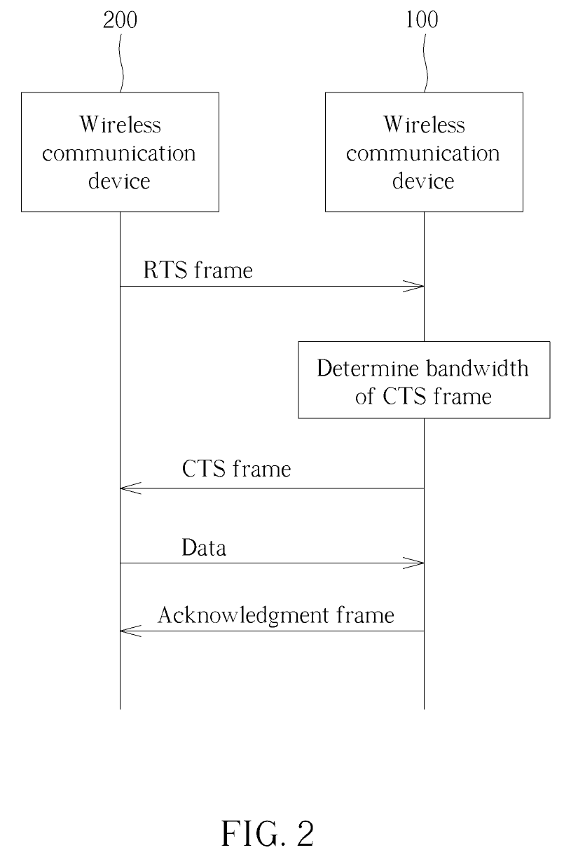

In this embodiment, the wireless communication device 100 may act as a reception side in a wireless communication environment and receive data from a transmission side (e.g., another wireless communication device). FIG. 2 is a communication flow between two wireless communication devices 100 and 200 according to an embodiment of the present disclosure, wherein a circuit architecture of the wireless communication device 200 is similar to that of the wireless communication device 100. Assume that the wireless communication device 200 requires transmitting data to the wireless communication device 100 (i.e., the wireless communication devices 100 and 200 act as the reception side and the transmission side, respectively).

As shown in FIG. 2, the wireless communication device 200 may initially transmit a request frame (e.g., a request to send (RTS) frame) requesting transmission of data to the wireless communication device 100. After receiving the request frame (e.g., the RTS frame), the wireless communication device 100 (more particularly, the processor 106) may determine (e.g., dynamically adjust) a bandwidth of a response frame (e.g., a clear to send (CTS) frame) according to a performance indicator PI, but the present disclosure is not limited thereto. In some embodiments, the processor 106 may determine the bandwidth of the response frame (e.g., the CTS frame) according to the performance indicator PI before receiving the request frame (e.g., the RTS frame). The determined bandwidth of the response frame comprises the size and location of the bandwidth of the response frame.

The following embodiments will be described by using the RTS frame and the CTS frame as examples. It should be noted that the RTS frame and the CTS frame are for illustration only, and are not meant to be limitations of the present disclosure. Any types of request frames and response frames fall within the scope of the present disclosure.

Afterwards, in response to reception of the RTS frame, the processor 106 may transmit the CTS frame to the wireless communication device 200 with the determined bandwidth. In response to reception of the CTS frame, the wireless communication device 200 may transmit data to the wireless communication device 100, and then receive an acknowledgment frame (e.g., an acknowledgment (ACK) frame or a block acknowledgment (BA) frame) from the wireless communication device 100.

The performance indicator PI may include at least one of a received signal strength indicator (RSSI) of a received packet from the wireless communication device 200, a transmission bandwidth T_BW of transmitted data of the wireless communication device 100, a Modulation and Coding Scheme (MCS) of the transmitted data of the wireless communication device 100 (hereinafter referred to as “a transmission MCS T_MCS” for brevity), a data rate of the transmitted data of the wireless communication device 100 (hereinafter referred to as “transmission data rate” for brevity), and a transmission power gap P_G between a first power with a connection capability bandwidth CC_BW for transmitting the CTS frame and a second power with a predetermined bandwidth for transmitting an acknowledgment frame, wherein the transmitted data of the wireless communication device 100 is the data transmitted from the wireless communication device 100 to the wireless communication device 200, both the first power and the second power may be preset, and the connection capability bandwidth CC_BW is a bandwidth negotiated between the wireless communication devices 100 and 200 for communication when a connection is established between the wireless communication devices 100 and 200.

It should be noted that the predetermined bandwidth for transmitting the acknowledgment frame may be preset based on transmission sensitivity. The transmission sensitivity refers to a transmission distance under a fixed transmission power. For example, in a 2G/5G wireless communication environment, the predetermined bandwidth may be set as 20 MHz. In another example, in a 6G wireless communication environment, the predetermined bandwidth may be set as the connection capability bandwidth CC_BW.

In this embodiment, the processor 106 in the wireless communication device 100 first determines whether data traffic of the wireless communication device 100 is presented (i.e., whether the data traffic of the wireless communication device 100 exists), in order to generate a determination result DET_RLT. If the amount of data transmitted or expected to be transmitted from the wireless communication device 100 to the wireless communication device 200 during a predetermined period is larger than a threshold, the data traffic of the wireless communication device 100 is presented. If the amount of data transmitted or expected to be transmitted from the wireless communication device 100 to the wireless communication device 200 during the predetermined period is not larger than the threshold, the data traffic of the wireless communication device 100 is not presented. In response to the determination result DET_RLT indicating that the data traffic is presented, it is determined as a normal traffic case, and the bandwidth of the CTS frame is dynamically determined according to at least one of the transmission bandwidth T_BW, the transmission MCS T_MCS, the transmission data rate, and the transmission power gap P_G. In response to the determination result DET_RLT indicating that data traffic is not presented, it is determined as a low traffic case, and the bandwidth of the CTS frame is dynamically determined according to the RSSI of a received packet from the wireless communication device 200. For example, the received packet may be the RTS or a beacon from the wireless communication device 200.

For the normal traffic case, sufficient packet information may be obtained to determine the transmission bandwidth T_BW and the transmission MCS T_MCS for data transmission. The bandwidth of the CTS frame may be dynamically determined according to the transmission bandwidth T_BW and/or the transmission MCS T_MCS for data transmission.

For example, the processor 106 may determine whether the transmission bandwidth T_BW is less than the connection capability bandwidth CC_BW. In response to the transmission bandwidth T_BW being less than the connection capability bandwidth CC_BW, the processor 106 determines the bandwidth of the CTS frame as the bandwidth of the acknowledgment frame such that the size and location of the bandwidth for the transmission of the CTS frame is the same as the size and location of the bandwidth for the transmission of acknowledgment frame (i.e., the bandwidth of the CTS frame aligns with that of the acknowledgment frame). In response to the transmission bandwidth T_BW not being less than the connection capability bandwidth CC_BW, the processor 106 determines the bandwidth of the CTS frame as the bandwidth of the RTS frame such that the size and location of the bandwidth for the transmission of the CTS frame is the same as the size and location of the bandwidth for the transmission of RTS frame (i.e., the bandwidth of the CTS frame aligns with that of the RTS frame). The bandwidth of RTS frame is larger than that of the acknowledgment frame.

In terms of data transmission, compared to transmitting data over a larger bandwidth, transmitting data over a smaller bandwidth results in a higher power spectrum density on the smaller bandwidth, so the data can be transmitted over a longer distance. Because the transmission bandwidth T_BW of transmitted data is less than the connection capability bandwidth CC_BW, it can be seen that the distance between the wireless communication device 200 and the wireless communication device 100 is long. Therefore, by using the bandwidth of the CTS frame aligning with the bandwidth of the acknowledgment frame, the CTS frame can be transmitted over a long distance. With this arrangement, it ensures that the CTS frame can be received by the wireless communication device 200.

In another example, the processor 106 may determine whether the transmission MCS T_MCS is less than a threshold MCS TH_MCS. In response to the transmission MCS T_MCS being less than the threshold MCS TH_MCS, the processor 106 determines the bandwidth of the CTS frame as the bandwidth of the acknowledgment frame (i.e., the bandwidth of the CTS frame aligns with that of the acknowledgment frame). In response to the transmission MCS T_MCS not being less than the threshold MCS TH_MCS, the processor 106 determines the bandwidth of the CTS frame as the bandwidth of the RTS frame (i.e., the bandwidth of the CTS frame aligns with that of the RTS frame).

In an embodiment of the present disclosure, the processor 106 may dynamically determine the bandwidth of the CTS frame according to the transmission power gap P_G between a first power with a connection capability bandwidth CC_BW for transmitting the CTS frame and a second power with a predetermined bandwidth for transmitting an acknowledgment frame. For example, the connection capability bandwidth CC_BW may be 40MHz or 80MHz, and the predetermined bandwidth for transmitting an acknowledgment frame may be 20MHz. For example, the processor 106 may determine whether the transmission power gap P_G is less than a threshold power gap TH_PG. In response to the transmission power gap P_G being less than the threshold power gap TH_PG, the processor 106 determines the bandwidth of the CTS frame as the bandwidth of the acknowledgment frame (i.e., the bandwidth of the CTS frame aligns with that of the acknowledgment frame). In response to the transmission power gap P_G not being less than the threshold power gap TH_PG, the processor 106 determines the bandwidth of the CTS frame as the bandwidth of the RTS frame (i.e., the bandwidth of the CTS frame aligns with that of the RTS frame).

In an embodiment of the present disclosure, after transmitting the data, if the wireless communication device 100 fails to receive an acknowledgment frame from the wireless communication device 200, the wireless communication device 100 may select a transmission data rate corresponding to a reduced transmission bandwidth and/or a reduced MCS. The bandwidth of the CTS frame may then be dynamically determined according to the transmission data rate. For example, the processor 106 may determine the bandwidth of the CTS frame as the bandwidth of the acknowledgment frame (i.e., the bandwidth of the CTS frame aligns with that of the acknowledgment frame) when the transmission data rate is less than a threshold data rate. The processor 106 may determine the bandwidth of the CTS frame as the bandwidth of the RTS frame (i.e., the bandwidth of the CTS frame aligns with that of the RTS frame) when the transmission data rate is not less than the threshold data rate.

For the low traffic case, the bandwidth of the CTS frame may be dynamically determined according to the RSSI of the received packet. For example, the processor 106 may determine whether the RSSI is less than or equal to a threshold value TH_RSSI. In response to the RSSI being less than or equal to the threshold value TH_RSSI, the processor 106 determines that the distance between the wireless communication device 100 and the transmission side (e.g., the wireless communication device 200) is relatively long, and therefore determines the bandwidth of the CTS frame as the bandwidth of the acknowledgment frame (i.e., the bandwidth of the CTS frame aligns with the bandwidth of the acknowledgment frame). In response to the RSSI not being less than or equal to the threshold value TH_RSSI, the processor 106 determines the bandwidth of the CTS frame as the bandwidth of the RTS frame (i.e., the bandwidth of the CTS frame aligns with that of the RTS frame).

In embodiments of the present disclosure, by dynamically determining the bandwidth of the CTS frame as a bandwidth which is narrower than the bandwidth of the RTS frame, a transmission PSD gap between a transmission PSD of the wireless communication device 100 for transmitting the CTS frame and a transmission PSD of the wireless communication device 200 for transmitting the RTS frame can be minimized, and the transmission distance of the CTS frame can be greatly improved to ensure the CTS frame is received by the wireless communication device 200. In addition, a trade-off between the transmission sensitivity of the CTS frame and an anti-interference capability of the CTS frame can be optimized by dynamically determining the bandwidth of the CTS frame as a bandwidth which is narrower than the bandwidth of the RTS frame. For example, the anti-interference capability may be associated with hidden nodes and exposed nodes, but the present disclosure is not limited thereto.

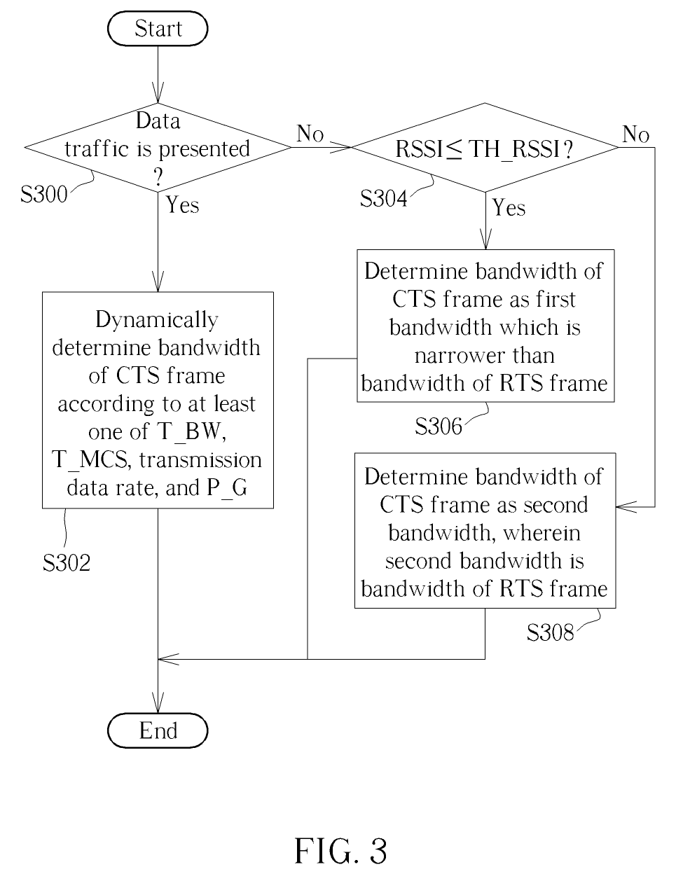

FIG. 3 is a flow chart of dynamically determining a bandwidth of a response frame for a normal traffic case and a low traffic case according to an embodiment of the present disclosure. Provided that the result is substantially the same, the steps are not required to be executed in the exact order shown in FIG. 3. For example, the method shown in FIG. 3 may be employed by the wireless communication device 100 shown in FIG. 1.

In Step S300, it is determined whether data traffic of the wireless communication device 100 is presented. If Yes, Step S302 is entered; if No, Step S304 is entered.

In Step S302, it is determined as the normal traffic case, and the bandwidth of the CTS frame is dynamically determined according to at least one of the transmission bandwidth T_BW, the transmission MCS T_MCS, the transmission data rate, and the transmission power gap P_G.

In Step S304, it is determined as the low traffic case. In addition, it is determined whether the RSSI is less than or equal to the threshold value TH_RSSI. If Yes, Step S306 is entered; if No, Step S308 is entered.

In Step S306, the bandwidth of the CTS frame is determined as a first bandwidth which is narrower than the bandwidth of the RTS frame. The first bandwidth may be the bandwidth of the acknowledgment frame. In an alternatively embodiment, the first bandwidth may be the bandwidth of the transmitted data of the wireless communication device 100.

In Step S308, the bandwidth of the CTS frame is determined as a second bandwidth, wherein the second bandwidth is the bandwidth of the RTS frame.

Since a person skilled in the pertinent art can readily understand details of the steps after reading above paragraphs, further description is omitted here for brevity.

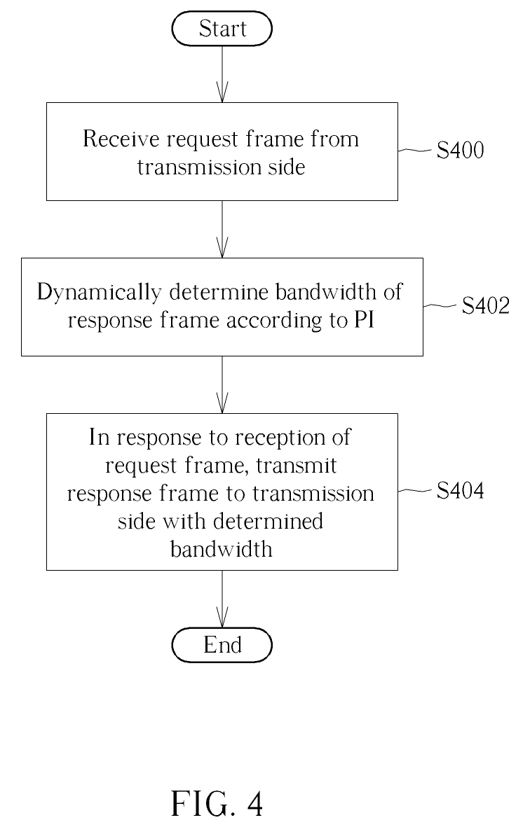

FIG. 4 is a flow chart of a method for dynamically determining a bandwidth of a response frame according to an embodiment of the present disclosure. Provided that the result is substantially the same, the steps are not required to be executed in the exact order shown in FIG. 4. For example, the method shown in FIG. 4 may be employed by the wireless communication device 100 shown in FIG. 1.

In Step S400, a request frame (e.g., an RTS frame) is received from a transmission side (e.g., another wireless communication device, such as the wireless communication device 200 shown in FIG. 2).

In Step S402, the bandwidth of the response frame (e.g., a CTS frame) is dynamically determined according to the performance indicator PI associated with a transmission or a reception of the wireless communication device 100.

In Step S404, in response to reception of the request frame, the response frame is transmitted to the wireless communication device 200 with the determined bandwidth.

Since a person skilled in the pertinent art can readily understand details of the steps after reading above paragraphs, further description is omitted here for brevity.

In summary, by the method and the wireless communication device of the present disclosure, the bandwidth of the CTS frame can be dynamically determined according to the performance indicator, which can prevent the CTS frame from not being received due to minimizing the transmission PSD gap between a transmission PSD of the reception side (e.g., the wireless communication device 100) for transmitting the CTS frame and a transmission PSD of the transmission side (e.g., the wireless communication device 200) for transmitting the RTS frame within a wireless communication environment. More particularly, retransmission events of the RTS frame caused by the transmission side being unable to receive the CTS frame can be prevented, thereby effectively reducing system costs and improving data transmission efficiency.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing

What is claimed is:

1. A method for dynamically determining a bandwidth of a response frame, comprising:
receiving, by a first wireless communication device, a request frame from a second wireless communication device;
dynamically determining, by the first wireless communication device, the bandwidth of the response frame according to a performance indicator associated with a transmission or a reception of the first wireless communication device; and
in response to reception of the request frame, transmitting, by the first wireless communication device, the response frame to the second wireless communication device with the determined bandwidth.

2. The method of claim 1, further comprising:
determining whether data traffic of the first wireless communication device is presented in order to generate a determination result, wherein the bandwidth of the response frame is dynamically determined according to the performance indicator associated with the determination result.

3. The method of claim 2, wherein in response to the data traffic of the first wireless communication device not being presented, the performance indicator is a received signal strength indicator (RSSI) of a received packet from the second wireless communication device.

4. The method of claim 3, wherein the step of dynamically determining, by the first wireless communication device, the bandwidth of the response frame according to the performance indicator associated with the determination result comprises:
determining whether the RSSI is less than or equal to a threshold RSSI;
in response to the RSSI being less than or equal to the threshold RSSI, determining the bandwidth of the response frame as a first bandwidth, wherein the first bandwidth is narrower than a bandwidth of the request frame; and
in response to the RSSI not being less than or equal to the threshold RSSI, determining the bandwidth of the response frame as a second bandwidth, wherein the second bandwidth is the bandwidth of the request frame.

5. The method of claim 2, wherein in response to the data traffic of the first wireless communication device being presented, the performance indicator is a transmission bandwidth of transmitted data of the first wireless communication device.

6. The method of claim 5, wherein a connection capability bandwidth is a bandwidth negotiated between the first wireless communication device and the second wireless communication device for communication when a connection is established between the first wireless communication device and the second communication; and the step of dynamically determining, by the first wireless communication device, the bandwidth of the response frame according to the performance indicator associated with the determination result comprises:
determining whether the transmission bandwidth of transmitted data is less than the connection capability bandwidth;
in response to the transmission bandwidth of transmitted data being less than the connection capability bandwidth, determining the bandwidth of the response frame as a first bandwidth, wherein the first bandwidth is narrower than a bandwidth of the request frame; and
in response to the transmission bandwidth not being less than the connection capability bandwidth, determining the bandwidth of the response frame as a second bandwidth, wherein the second bandwidth is the bandwidth of the request frame.

7. The method of claim 2, wherein in response to the data traffic of the first wireless communication device being presented, the performance indicator is a Modulation and Coding Scheme (MCS) of transmitted data of the first wireless communication device.

8. The method of claim 7, wherein the step of dynamically determining, by the first wireless communication device, the bandwidth of the response frame according to the performance indicator associated with the determination result comprises:
determining whether the MCS of transmitted data is less than a threshold MCS;
in response to the MCS of transmitted data being less than the threshold MCS, determining the bandwidth of the response frame as a first bandwidth, wherein the first bandwidth is narrower than a bandwidth of the request frame; and
in response to the MCS of transmitted data not being less than the threshold MCS, determining the bandwidth of the response frame as a second bandwidth, wherein the second bandwidth is the bandwidth of the request frame.

9. The method of claim 2, wherein a connection capability bandwidth is a bandwidth negotiated between the first wireless communication device and the second wireless communication device for communication when a connection is established between the first wireless communication device and the second wireless communication device, a transmission power gap is between a first power with the connection capability bandwidth for transmitting the response frame and a second power with a predetermined bandwidth for transmitting an acknowledgment frame; and in response to the data traffic of the first wireless communication device being presented, the performance indicator is the transmission power gap.

10. The method of claim 9, wherein the step of dynamically determining, by the first wireless communication device, the bandwidth of the response frame according to the performance indicator associated with the determination result comprises:
determining whether the transmission power gap is less than a threshold power gap;
in response to the transmission power gap being less than the threshold power gap, determining the bandwidth of the response frame as a first bandwidth, wherein the first bandwidth is narrower than a bandwidth of the request frame; and
in response to the transmission power gap not being less than the threshold power gap, determining the bandwidth of the response frame as a second bandwidth, wherein the second bandwidth is the bandwidth of the request frame.

11. The method of claim 2, wherein in response to the data traffic of the first wireless communication device being presented, the performance indicator is a data rate of transmitted data of the first wireless communication device.

12. The method of claim 11, wherein the step of dynamically determining, by the first wireless communication device, the bandwidth of the response frame according to the performance indicator associated with the determination result comprises:
determining the bandwidth of the response frame as a first bandwidth when the data rate of transmitted data is less than a threshold data rate, wherein the first bandwidth is narrower than a bandwidth of the request frame; and
determining the bandwidth of the response frame as a second bandwidth when the data rate of transmitted data is not less than the threshold data rate, wherein the second bandwidth is the bandwidth of the request frame.

13. The method of claim 2, wherein the determined bandwidth is a bandwidth of an acknowledgment frame from the first wireless communication device to the second wireless communication device, and the bandwidth of the acknowledgment frame is narrower than a bandwidth of the request frame.

14. A wireless communication device, comprising:
a wireless transceiver circuit; and
a processor, coupled to the wireless transceiver circuit, wherein the processor performs operations comprising:
receiving a request frame from another wireless communication device;
dynamically determining a bandwidth of a response frame according to a performance indicator associated with a transmission or a reception of the wireless communication device; and
in response to reception of the request frame, transmitting the response frame to the another wireless communication device with the determined bandwidth.

15. The wireless communication device of claim 14, wherein the operations performed by the processor further comprise:
determining whether data traffic of the wireless communication device is presented in order to generate a determination result, wherein the bandwidth of the response frame is dynamically determined according to the performance indicator associated with the determination result.

16. The wireless communication device of claim 15, wherein in response to the data traffic of the wireless communication device not being presented, the performance indicator is a received signal strength indicator (RSSI) of a received packet from the another wireless communication device; and the operations performed by the processor further comprise:
determining whether the RSSI is less than or equal to a threshold RSSI;
in response to the RSSI being less than or equal to the threshold RSSI, determining the bandwidth of the response frame as a first bandwidth, wherein the first bandwidth is narrower than a bandwidth of the request frame; and
in response to the RSSI not being less than or equal to the threshold RSSI, determining the bandwidth of the response frame as a second bandwidth, wherein the second bandwidth is the bandwidth of the request frame.

17. The wireless communication device of claim 15, wherein in response to the data traffic of the wireless communication device being presented, the performance indicator is a transmission bandwidth of transmitted data of the wireless communication device; a connection capability bandwidth is a bandwidth negotiated between the wireless communication device and the another wireless communication device for communication when a connection is established between the wireless communication device and the another communication; and the operations performed by the processor further comprise:
determining whether the transmission bandwidth of transmitted data is less than the connection capability bandwidth;
in response to the transmission bandwidth of transmitted data being less than the connection capability bandwidth, determining the bandwidth of the response frame as a first bandwidth, wherein the first bandwidth is narrower than a bandwidth of the request frame; and
in response to the transmission bandwidth not being less than the connection capability bandwidth, determining the bandwidth of the response frame as a second bandwidth, wherein the second bandwidth is the bandwidth of the request frame.

18. The wireless communication device of claim 15, wherein in response to the data traffic of the wireless communication device being presented, the performance indicator is a Modulation and Coding Scheme (MCS) of transmitted data of the wireless communication device; and the operations performed by the processor further comprise:
determining whether the MCS of transmitted data is less than a threshold MCS;
in response to the MCS of transmitted data being less than the threshold MCS, determining the bandwidth of the response frame as a first bandwidth, wherein the first bandwidth is narrower than a bandwidth of the request frame; and
in response to the MCS of transmitted data not being less than the threshold MCS, determining the bandwidth of the response frame as a second bandwidth, wherein the second bandwidth is the bandwidth of the request frame.

19. The wireless communication device of claim 15, wherein a connection capability bandwidth is a bandwidth negotiated between the wireless communication device and the another wireless communication device for communication when a connection is established between the wireless communication device and the another wireless communication device, a transmission power gap is between a first power with the connection capability bandwidth for transmitting the response frame and a second power with a predetermined bandwidth for transmitting an acknowledgment frame; in response to the data traffic of the wireless communication device being presented, the performance indicator is the transmission power gap; and the operations performed by the processor further comprise:
determining whether the transmission power gap is less than a threshold power gap;
in response to the transmission power gap being less than the threshold power gap, determining the bandwidth of the response frame as a first bandwidth, wherein the first bandwidth is narrower than a bandwidth of the request frame; and
in response to the transmission power gap not being less than the threshold power gap, determining the bandwidth of the response frame as a second bandwidth, wherein the second bandwidth is the bandwidth of the request frame.

20. The wireless communication device of claim 15, wherein in response to the data traffic of the wireless communication device being presented, the performance indicator is a data rate of transmitted data of the wireless communication device; and the operations performed by the processor further comprise:
determining whether the data rate of transmitted data is less than a threshold data rate;
determining the bandwidth of the response frame as a first bandwidth when the data rate of transmitted data is less than a threshold data rate, wherein the first bandwidth is narrower than a bandwidth of the request frame; and
determining the bandwidth of the response frame as a second bandwidth when the data rate of transmitted data is not less than the threshold data rate, wherein the second bandwidth is the bandwidth of the request frame.
